(19) United States
(12) Patent Application Publication
(10) Pub. No.: US 2014/0104152 A1
(43) Pub. Date: Apr. 17, 2014

(54) SHIFT REGISTER, GATE DRIVING APPARATUS OF LIQUID CRYSTAL DISPLAY AND LIQUID CRYSTAL DISPLAY

(71) Applicants: HEFEI BOE OPTOELECTRONICS TECHNOLOGY CO., LTD., Anhui (CN); BOE TECHNOLOGY GROUP CO., LTD., Beijing (CN)

(72) Inventors: Rui MA, Beijing (CN); Xianjie SHAO, Beijing (CN); Guolei WANG, Beijing (CN); Ming HU, Beijing (CN)

(73) Assignees: HEFEI BOE OPTOELECTRONICS TECHNOLOGY CO., LTD., Anhui (CN); BOE TECHNOLOGY GROUP CO., LTD., Beijing (CN)

(21) Appl. No.: 14/050,578

(22) Filed: Oct. 10, 2013

(30) Foreign Application Priority Data
Oct. 11, 2012 (CN) 201210384048.8

(51) Int. Cl. G09G 3/36

(52) U.S. Cl. CPC G09G 3/3648
USPC 345/100

(57) ABSTRACT

Embodiments of the present applicant provide a shift register which comprises a pulling-up module for connecting electrically a clock signal inputting terminal with a control signal outputting terminal under a control of a signal received from a control signal inputting terminal; a resetting module for resetting a pulling-up node and the control signal outputting terminal under a control of a signal received from a reset signal inputting terminal; a pulling-down module for connecting electrically the control signal outputting terminal with a low voltage signal inputting terminal under controls of the signal received from the clock signal inputting terminal and a signal at the pulling-up node, wherein the pulling-up node is a connection point where the pulling-up module, the resetting module and the pulling-down module are connected together.

### TECHNICAL FIELD

The present invention relates to a field of liquid crystal display, and in particularly to a shift register, a gate driving apparatus of a liquid crystal display and a liquid crystal display.

### BACKGROUND

A panel of a liquid crystal display is composed of a two-dimension array of liquid crystal pixels. A driving apparatus in the panel of the liquid crystal display comprises a gate driving apparatus and a data driving apparatus, wherein the data driving apparatus latches the input display data sequentially and converts the same into an analog signal, and then scans data lines on the panel of the liquid crystal display in order; the gate driving apparatus comprises several shift registers, and a signal at a control signal outputting terminal of a current stage shift register may be transmitted to a reset signal inputting terminal of a previous stage shift register and a control signal inputting terminal of a next stage shift register. Each stage of the shift registers converts an input clock signal into an ON or OFF signal and outputs the same to a corresponding gate line via its control signal outputting terminal.

A typical structure of an existing shift register is as illustrated in FIG. 1, and FIG. 2 is a diagram illustrating an operational timing sequence of the shift register shown in FIG. 1. Its operational principle is as follows.

During a first stage, a control signal inputting terminal INPUT is at a high potential, a reset signal inputting terminal RESETIN is at a low potential, a transistor T103 is turned on, a transistor T101, a transistor T102, a transistor T104 are turned off, and a capacitor C102 is charged through the transistor T103, thus a connection point P is at a high potential;

during a second stage, the control signal inputting terminal INPUT is at a low potential, the reset signal inputting terminal RESETIN is at the low potential, a clock signal inputting terminal CLKIN is at the high potential, the transistor T101 is turned on, therefore a control signal outputting terminal OUTPUT outputs a high level signal; since the transistor T102, the transistor T103, the transistor T104 are turned off, and the connection point P is in a floating state at this time; the control signal outputting terminal OUTPUT is at the high potential, and the high potential couples to the connection point P through the capacitor C102, thus the potential at the connection point P rises continuously on a basis of the potential during the first stage;

during a third stage, the control signal inputting terminal INPUT is at the low potential, the reset signal inputting terminal RESETIN inputs a high level signal, the transistors T102 and T104 are turned on, the transistor T101, the transistor T103 are turned off, the capacitor C102 discharges, and thus the connection point P is at the low potential; the control signal outputting terminal OUTPUT is at the low potential since a source of the T102 is connected with a low voltage signal inputting terminal VSSIN;

during a fourth stage, the control signal inputting terminal INPUT is at the low potential, the reset signal inputting terminal RESETIN is at the low potential, so all of the transistor T101, the transistor T102, the transistor T103 and the transistor T104 are turned off, and thus the signal output from the control signal outputting terminal OUTPUT remains the low potential;

during a fifth stage, the input signal of the control signal inputting terminal INPUT is at the low potential, the reset signal inputting terminal RESETIN is at the low potential, the transistor T101, the transistor T102, the transistor T103 and the transistor T104 remain their states during the fourth stage, and thus the control signal outputting terminal OUTPUT is still at the low potential.

During these five stages, the control signal inputting terminal INPUT inputs a high level signal during the first stage, the control signal outputting terminal OUTPUT outputs a high level signal during the second stage, and thus a shift operation is completed; the reset signal inputting terminal RESETIN inputs a high level signal during the third stage to complete a resetting operation; therefore, the first, second and third stages are defined as an operating period of time of the shift register, and the fourth and fifth stages are defined as a non-operating period of time of the shift register.

It can be seen that during the non-operating period of time, the control signal inputting terminal INPUT, the reset signal inputting terminal RESETIN and the control signal outputting terminal OUTPUT are all at the low level, and a high potential at the clock signal inputting terminal CLKIN may couple to the connection point P through a parasitic capacitance between a gate and drain of the transistor T101 when the clock signal inputting terminal CLKIN is at a high level, such that a leakage current in the transistor T101 is increased, which may cause a rise in potential at the control signal outputting terminal OUTPUT. Also, because the transistor T103, the transistor T104 and the transistor T102 are all turned off during the non-operating period of time, a voltage at the control signal outputting terminal OUTPUT fails to drop, such that notable coupling noise occurs in the output signals from the control signal outputting terminal OUTPUT.

In conclusion, in the existing shift register, the high level signal at the clock signal inputting terminal CLKIN may couple to the control signal outputting terminal OUTPUT through the parasitic capacitance between the gate and drain of the transistor T101 when the clock signal inputting terminal CLKIN is at the high potential during the non-operating period of time, and the control signal outputting terminal OUTPUT is in a floating state during the non-operating period of time, such that the noise due to the coupling of the high level signal at the clock signal inputting terminal CLKIN to the control signal outputting terminal OUTPUT can not be eliminated and is output along with the signal from the control signal outputting terminal OUTPUT, and as a result, there serious noise occurs in the signal output from the control signal outputting terminal OUTPUT.

### SUMMARY

Embodiments of the present application provide a shift register which can address the issue of serious noise occurring in the signal output from a control signal outputting terminal of the existing shift registers during a non-operating period of time, and a gate driving apparatus of a liquid crystal display.

In view of the above, an embodiment of the present application provides a shift register, comprising:

a pulling-up module for connecting electrically a clock signal inputting terminal with a control signal outputting terminal under a control of a signal received from a control signal inputting terminal;

a resetting module for resetting a pulling-up node and the control signal outputting terminal under a control of a signal received from a reset signal inputting terminal;

a pulling-down module for connecting electrically the control signal outputting terminal with a low voltage signal inputting terminal under controls of the signal received from the clock signal inputting terminal and a signal of the pulling-up node, the pulling-up node is a connection point where the pulling-up module, the resetting module and the pulling-down module are connected together.

Another embodiment of the present application further provides a gate driving apparatus of a liquid crystal display, which comprising a plurality of stages of shift registers; except a first stage shift register and a last stage shift register, a control signal outputting terminal of each stage of other shift registers is connected to a reset signal inputting terminal of its previous stage shift register and a control signal inputting terminal of its next stage shift register; a control signal inputting terminal of the first stage shift register is connected to an initial trigger signal terminal, and a reset signal inputting terminal of the last stage shift register is in a floating state, or is connected to the control signal outputting terminal of its own directly or is connected to a control signal outputting terminal of a redundant shift register added.

Another embodiment of the present application further provides a liquid crystal display apparatus comprising the gate driving apparatus of the liquid crystal display provided by the embodiment of the present application.

The embodiments of the present application provide the shift register and the gate driving apparatus of the liquid crystal display, wherein the pulling-down module of the shift register may connect electrically the control signal outputting terminal with the low voltage signal inputting terminal under the controls of the signal received from the clock signal inputting terminal and the signal of the pulling-up node during a non-operating period of time of the shift register, that is, the control signal outputting terminal is pulled down to a low potential, such that the control signal outputting terminal is not in a floating state and a potential of noise caused by the coupling of the high level signal of the clock signal inputting terminal to the control signal outputting terminal is decreased to the low potential. Thus the noise caused by the coupling of the high level signal of the clock signal inputting terminal to the control signal outputting terminal is eliminated and in turn the noise in the signal output from the control signal outputting terminal is reduced.

### BRIEF DESCRIPTION OF THE DRAWINGS

FIG. 1 is an exemplary view illustrating a structure of a shift register in the prior art;

FIG. 2 is a diagram illustrating an operational timing sequence of the shift register in the prior art;

FIG. 3 is a first exemplary view illustrating a shift register according to the embodiments of the present application;

FIG. 4 is a second exemplary view illustrating a shift register according to the embodiments of the present application;

FIG. 5 is a third exemplary view illustrating a shift register according to the embodiments of the present application;

FIG. 6 is a fourth exemplary view illustrating a shift register according to the embodiments of the present application;

FIG. 7 is a diagram illustrating an operational timing sequence of the shift register according to the embodiments of the present application;

FIG. 8a is a first exemplary view illustrating a structure of a gate driving apparatus of a liquid crystal display according to the embodiments of the present application;

FIG. 8b is a second exemplary view illustrating a structure of a gate driving apparatus of a liquid crystal display according to the embodiments of the present application; and

FIG. 8c is a third exemplary view illustrating a structure of a gate driving apparatus of a liquid crystal display according to the embodiments of the present application.

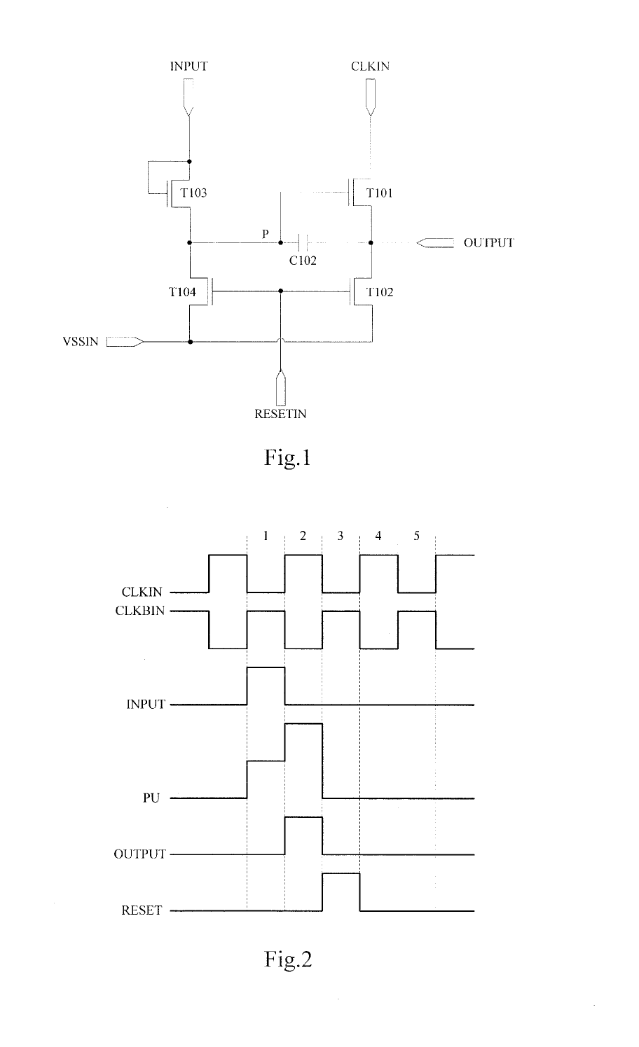

### DETAILED DESCRIPTION

Below will describe implementations of a shift register and a gate driving apparatus of a liquid crystal display according to the embodiments of the present application in details with reference to the accompanying drawings.

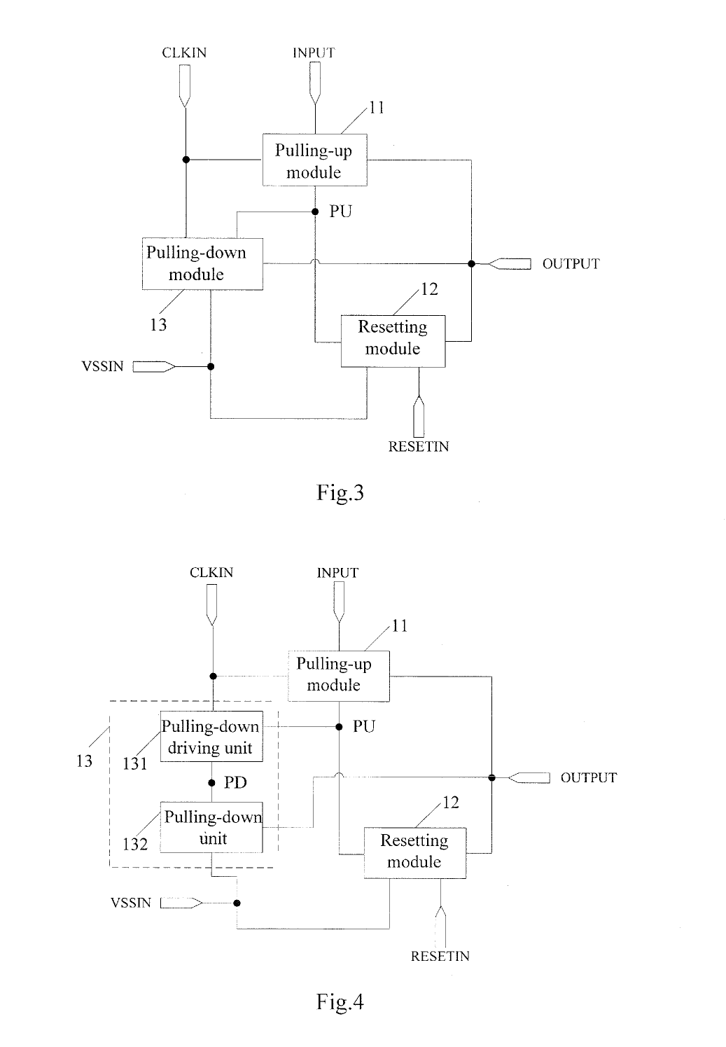

In particularly, the shift register according to the embodiments of the present application comprises a pulling-up module 11, a resetting module 12 and a pulling-down module 13, as illustrated in FIG. 3.

The pulling-up module 11 is used for connecting electrically a clock signal inputting terminal CLKIN with a control signal outputting terminal OUTPUT under a control of a signal received from a control signal inputting terminal INPUT.

The pulling-up module 11 outputs a high level signal to the control signal outputting terminal OUTPUT when a signal received from the clock signal inputting terminal CLKIN changes to a high level signal from a low level signal after the pulling-up module 11 receives the low level signal from the clock signal inputting terminal CLKIN and receives the high level signal from the control signal inputting terminal INPUT.

The resetting module 12 is used for resetting a pulling-up node PU and the control signal outputting terminal OUTPUT under a control of a signal received from a reset signal inputting terminal RESETIN.

The resetting module 12 resets the pulling-up node PU and the control signal outputting terminal OUTPUT to a low potential when it receives a high level signal from the reset signal inputting terminal RESETIN.

The pulling-down module 13 is used for connecting electrically the control signal outputting terminal OUTPUT with a low voltage signal inputting terminal VSSIN under controls of the signal received from the clock signal inputting terminal CLKIN and a signal at the pulling-up node PU, the pulling-up node PU being a connection point where the pulling-up module 11, the resetting module 12 and the pulling-down module 13 are connected together.

The pulling-down module 13 connects electrically the control signal outputting terminal OUTPUT with the low voltage signal inputting terminal VSSIN when it receives a high level signal from the clock signal inputting terminal CLKIN and receives a low level signal from the pulling-up node PU; and the pulling-down module 13 disconnects electrically the control signal outputting terminal OUTPUT with the low voltage signal inputting terminal VSSIN when it receives a high level signal from the pulling-up node PU.

Further, the pulling-down module 13 of the shift register according to the embodiments of the present application comprises a pulling-down driving unit 131 and a pulling-down unit 132, as illustrated in FIG. 4.

The pulling-down driving unit 131 is used for outputting a driving signal to the pulling-down unit 132 under controls of the signal received from the clock signal inputting terminal CLKIN and the signal of the pulling-up node PU.

The pulling-down driving unit 131 outputs a high level signal to the pulling-down unit 132 when it receives a high level signal from the clock signal inputting terminal CLKIN and receives a low level signal from the pulling-up node PU, that is, the connection point PD is at a high potential; and the pulling-down driving unit 131 outputs a low level signal to the pulling-down unit 132 when it receives a high level signal from the clock signal inputting terminal CLKIN and receives a high level signal from the pulling-up node PU, that is, the connection point PD is at a low potential.

The pulling-down unit 132 is used for connecting electrically the control signal outputting terminal OUTPUT with the low voltage signal inputting terminal VSSIN under a control of the driving signal output from the pulling-down driving unit 131.

The pulling-down unit 132 connects electrically the control signal outputting terminal OUTPUT with the low voltage signal inputting terminal VSSIN when it receives a high level signal from the pulling-down driving unit 131; and the pulling-down unit 132 disconnects electrically the control signal outputting terminal OUTPUT with the low voltage signal inputting terminal VSSIN when it receives a low level signal from the pulling-down driving unit 131.

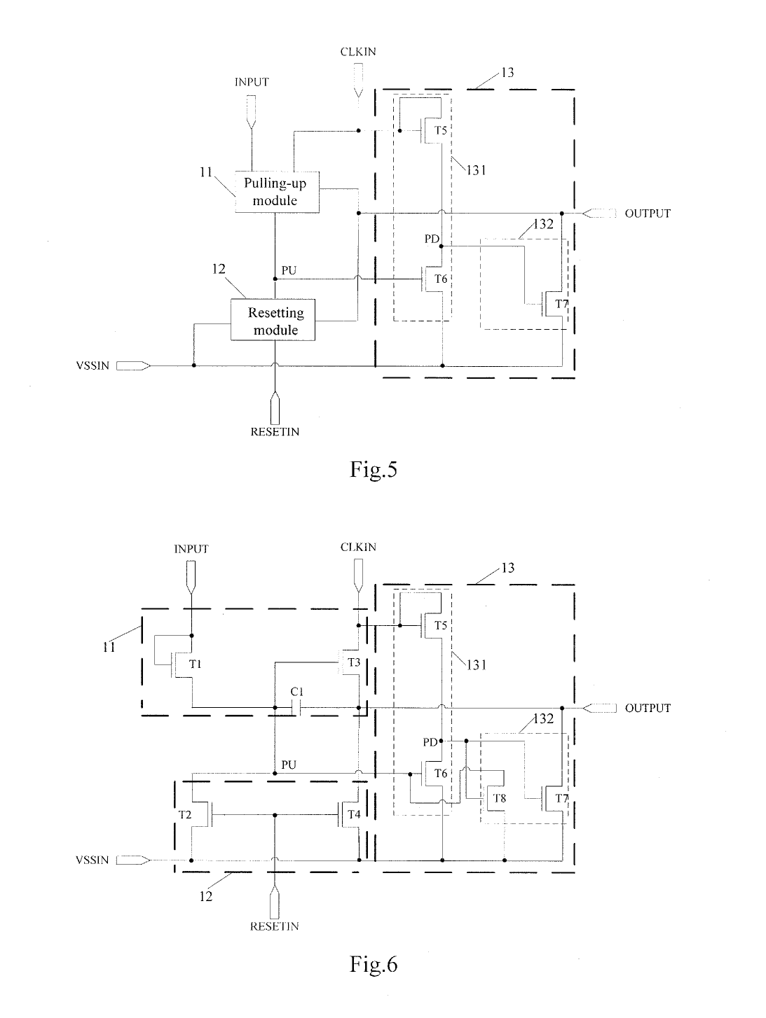

Further, the pulling-down driving unit 131 of the shift register according to the embodiments of the present application comprises a fifth transistor T5 and a sixth transistor T6, as illustrated in FIG. 5.

Drain and gate of the fifth transistor T5 are connected with the clock signal inputting terminal CLKIN, a source of the fifth transistor T5 is connected with a drain of the sixth transistor T6, a gate of the sixth transistor T6 is connected with the pulling-up module 11, that is, with the pulling-up node PU, a source of the sixth transistor T6 is connected with the low voltage signal inputting terminal VSSIN; a ratio of size of the fifth transistor T5 to that of the sixth transistor T6 is a preset value, for example, the ratio of size of the fifth transistor T5 to that of the sixth transistor T6 may be 1:4; the drain of the sixth transistor T6 is at a high potential, that is, the connection point PD is at the high potential, when the clock signal inputting terminal CLKIN is at a high potential and the pulling-up node PU is at a low potential, and the drain of the sixth transistor T6 is at a low potential, that is, the connection point PD is at the low potential, when the clock signal inputting terminal CLKIN is at a high potential and the pulling-up node PU is at a high potential.

Further, as illustrated in FIG. 5, the pulling-down unit 132 of the shift register according to the embodiments of the present application comprises a seventh transistor T7, wherein a gate of the seventh transistor T7 is connected with the drain of the sixth transistor T6, that is, with the connection point PD, a drain of the seventh transistor T7 is connected with the control signal outputting terminal OUTPUT, and a source of the seventh transistor T7 is connected with the low voltage signal inputting terminal VSSIN. Thus the seventh transistor T7 is turned off and the control signal outputting terminal OUTPUT is disconnected electrically with the low voltage signal inputting terminal VSSIN, when the drain of the sixth transistor T6 is at a low potential, that is, when the connection point PD is at a low potential; the seventh transistor T7 is turned on and the control signal outputting terminal OUTPUT is connected electrically with the low voltage signal inputting terminal VSSIN, when the drain of the sixth transistor T6 is at a high potential, that is, when the connection point PD is at a high potential, and as a result, a potential at the control signal outputting terminal OUTPUT is pulled down to the low potential, so that a potential of noise due to the coupling of the high level signal at the clock signal inputting terminal CLKIN to the control signal outputting terminal OUTPUT is decreased to the low potential during the non-operating period of time of the shift register; that is, the noise caused by the coupling of the high level signal of the clock signal inputting terminal CLKIN to the control signal outputting terminal OUTPUT is eliminated, and in turn noise in signal output from the control signal outputting terminal OUTPUT is reduced.

Preferably, as illustrated in FIG. 6, the pulling-down unit 132 of the shift register according to the embodiments of the present application further comprises an eighth transistor T8, wherein a gate of the eighth transistor T8 is connected with the drain of the sixth transistor T6, a drain of the eighth transistor T8 is connected with the pulling-up module 11 via the pulling-up node PU, and a source of the eighth transistor T8 is connected with the low voltage signal inputting terminal VSSIN. Thus the eighth transistor T8 is turned off and the pulling-up node PU is electrically disconnected with the low voltage signal inputting terminal when the drain of the sixth transistor T6 is at a low potential, that is, the connection point PD is at a low potential; and the eighth transistor T8 is turned on and the pulling-up node PU is connected electrically with the low voltage signal inputting terminal VSSIN when the drain of the sixth transistor T6 is at a high potential, that is, the connection point PD is at a high potential; that is to say, the potential at the pulling-up node PU is pulled down to a low potential; a potential of noise caused by a coupling of the high level signal at the clock signal inputting terminal CLKIN to the pulling-up node PU is decreased to the low potential during the non-operating period of time of the shift register, thus an influence of the noise at the pulling-up node PU on the signal from the control signal outputting terminal OUTPUT is eliminated, and in turn noise in the signal output from the control signal outputting terminal OUTPUT is further reduced.

Further, as illustrated in FIG. 6, the pulling-up module 11 of the shift register according to the embodiments of the present application comprises a first transistor T1, a third transistor T3 and a capacitor C1, wherein both gate and drain of the first transistor T1 are connected with the control signal inputting terminal INPUT, a source of the first transistor T1 is connected with the pulling-down module 13, namely the gate of the sixth transistor T6, and with one terminal of the capacitor C1, respectively, that is, the source of the first transistor T1 is connected with the pulling-up node PU, the other terminal of the capacitor C1 is connected with the control signal outputting terminal OUTPUT, a gate of the third transistor T3 is connected with the source of the first transistor T1, a drain of the third transistor T3 is connected with the clock signal inputting terminal CLKIN, and a source of the third transistor T3 is connected with the control signal outputting terminal OUTPUT.

Further, as illustrated in FIG. 6, the resetting module 12 of the shift register according to the embodiments of the present application comprises a second transistor T2 and a fourth transistor T4, wherein a gate of the second transistor T2 is connected with the reset signal inputting terminal RESETIN, a drain of the second transistor T2 is connected with the source of the first transistor T1, and with the pulling-down module 13, and a source of the second transistor T2 is connected with the low voltage signal inputting terminal VSSIN; a gate of the fourth transistor T4 is connected with the reset signal inputting terminal RESETIN, a drain of the fourth transistor T4 is connected with the control signal outputting terminal OUTPUT, and a source of the fourth transistor T4 is connected with the low voltage signal inputting terminal VSSIN.

It should note that there is no clear distinction between a drain and a source with respect to a transistor applied to the field of liquid crystal display, therefore the source of the transistor mentioned in the embodiments of the present application may be changed to the drain of the transistor, while the drain of the transistor may be changed to the source of the transistor.

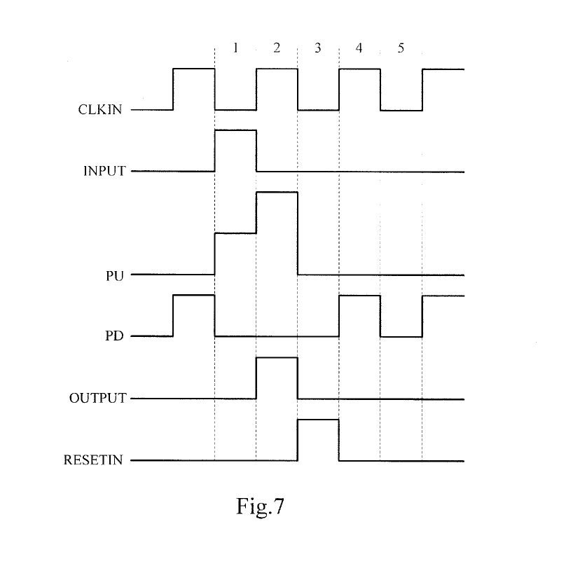

In order to further explain the shift register according to the embodiments of the present application, below will describe its operational principle in connection with a timing sequence diagram illustrated in FIG. 7.

As illustrated in FIG. 7, an operational timing sequence of the shift register according to the embodiments of the present application may be divided into five stages.

During the first stage: the control signal inputting terminal INPUT is input a high level signal, the first transistor T1 is turned on, the control signal inputting terminal INPUT charges the capacitor C1 through the first transistor T1, such that the potential at the pulling-up node PU is pulled up to a high potential, the third transistor T3 is turned on; the clock signal inputting terminal CLKIN is input a low level signal, the fifth transistor T is turned off, the sixth transistor T6 is turned on under the drive of the high potential at the pulling-up node PU, the connection point PD connecting the fifth transistor T5 with the sixth transistor T6 is connected to the low voltage signal inputting terminal VSSIN and is at the low potential, so the seventh transistor T7 and the eighth transistor T8 are turned off; the reset signal inputting terminal RESETIN is input a low level signal, the second transistor T2 and the fourth transistor T4 are turned off; the third transistor T3 is turned on, therefore the low level signal input from the clock signal inputting terminal CLKIN is transferred to the control signal outputting terminal OUTPUT via the third transistor T3, so that the control signal outputting terminal OUTPUT outputs the low level signal.

During the second stage, the control signal inputting terminal INPUT is input a low level signal, the first transistor T1 is turned off, but the pulling-up node PU is still at the high potential since the capacitor C1 has stored the high level signal input from the control signal inputting terminal INPUT during the first stage, the third transistor T3 remains on, therefore the high level signal input from the clock signal inputting terminal CLKIN is transferred to the control signal outputting terminal OUTPUT via the third transistor T3, a potential at the terminal of the capacitor C1 which is connected with the control signal outputting terminal OUTPUT also changes to the high potential from the low potential during the first stage, and a potential at the other terminal of the capacitor C1 which is connected with the pulling-up node PU rises continuously on a basis of the level during the first stage because of a bootstrap effect of the capacitor, that is, the potential at the pulling-up node PU rises continuously on the basis of the potential during the first stage; the reset signal inputting terminal RESETIN is input a low level signal, the second transistor T2 and the fourth transistor T4 are turned off; the clock signal inputting terminal CLKIN is input a high level signal, the fifth transistor T5 is turned on, the sixth transistor T6 is turned on under the drive of the high level signal from the pulling-up node PU; the connection point PD is maintained at the low potential by designing sizes of the fifth transistor T5 and the sixth transistor T6, that is to say, potentials at the gates of the seventh transistor T7 and the eighth transistor T8 remain at the low potential, which makes both of the seventh transistor T7 and the eighth transistor T8 remain off, that is, the control signal outputting terminal OUTPUT can not be electrically connected with the low voltage signal inputting terminal VSS, so that a stability in the output signals is ensured.

In the third stage, the control signal inputting terminal INPUT is input a low level signal, the clock signal inputting terminal CLKIN is input a low level signal, the reset signal inputting terminal RESETIN is input a high level signal, the second transistor T2 is turned on such that the pulling-up node PU is electrically connected with the low voltage signal inputting terminal VSSIN and the pulling-up node PU is reset to the low potential, the fourth transistor T4 is turned on such that the control signal outputting terminal OUTPUT is electrically connected with the low voltage signal inputting terminal VSSIN and the control signal outputting terminal OUTPUT is reset to the low potential.

In the fourth stage, the control signal inputting terminal INPUT is input a low level signal, the first transistor T1 is turned off, the pulling-up node PU remains at the low potential of the third stage, the sixth transistor T6 is turned off; the clock signal inputting terminal CLKIN is input a high level signal, the fifth transistor T5 is turned on, therefore the potentials at the gates of seventh transistor T7 and the eighth transistor T8 is at the high potential, both the seventh transistor T7 and the eighth transistor T8 are turned on, so that the pulling-up node PU is electrically connected with the low voltage signal inputting terminal VSSIN and the control signal outputting terminal OUTPUT is electrically connected with the low voltage signal inputting terminal VSSIN, and as a result, the coupling noise occurring at the pulling-up node PU and that occurring at the control signal outputting terminal OUTPUT, due to a parasitic capacitance between the gate and drain of the third transistor T3 when the clock signal inputting terminal CLKIN is input the high level signal, is eliminated. Turning on the seventh transistor T7 may eliminate the coupling noise occurring at the control signal outputting terminal OUTPUT, due to the high level signal input from the clock signal inputting terminal CLKIN, and reduce the noise in the signal output from the control signal outputting terminal OUTPUT; while turning on the eighth transistor T8 may eliminate the coupling noise occurring at the pulling-up node PU, due to the high level signal input from the clock signal inputting terminal CLKIN, and in turn eliminate an influence of the coupling noise on the control signal outputting terminal OUTPUT and further reduce the noise in the signal output from the control signal outputting terminal OUTPUT.

During the fifth stage, the control signal inputting terminal INPUT is input a low level signal, the first transistor T1 is turned off, the pulling-up node PU remains at the low potential of the third stage, the sixth transistor T6 is turned off; the clock signal inputting terminal CLKIN is input a low level signal, the fifth transistor T5 is turned off, therefore the potentials at the gates of the seventh transistor T7 and the eighth transistor T8 are at the low potential, and thus both of the seventh transistor T7 and the eighth transistor T8 are turned off.

After that, the fourth stage and the fifth stage are repeated in order until the shift register according to the embodiments of the present application receives a high level signal from the control signal inputting terminal INPUT, and then the first stage is performed again. In this way, during the fourth stage and the fifth stage, namely a non-operating period of time of the shift register according to the embodiments of the present application, the potentials at the gates of the seventh transistor T7 and the eighth transistor T8 are switched between the high potential and the low potential continually, so that the seventh transistor T7 and the eighth transistor T8 are controlled to be turned on and turned off continually.

The embodiments of the present application further provide a gate driving apparatus of a liquid crystal display, wherein the apparatus may be implemented in three manners.

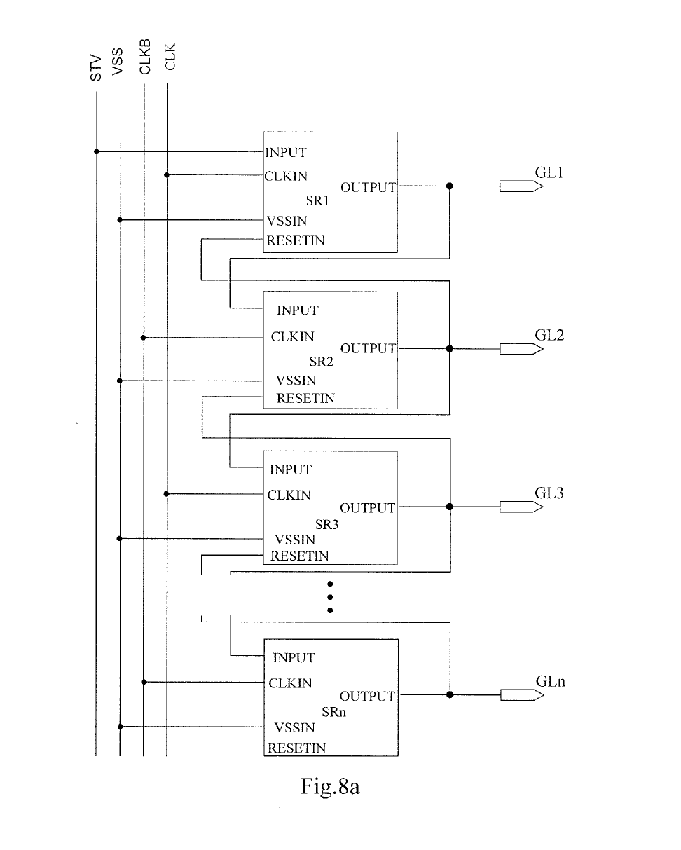

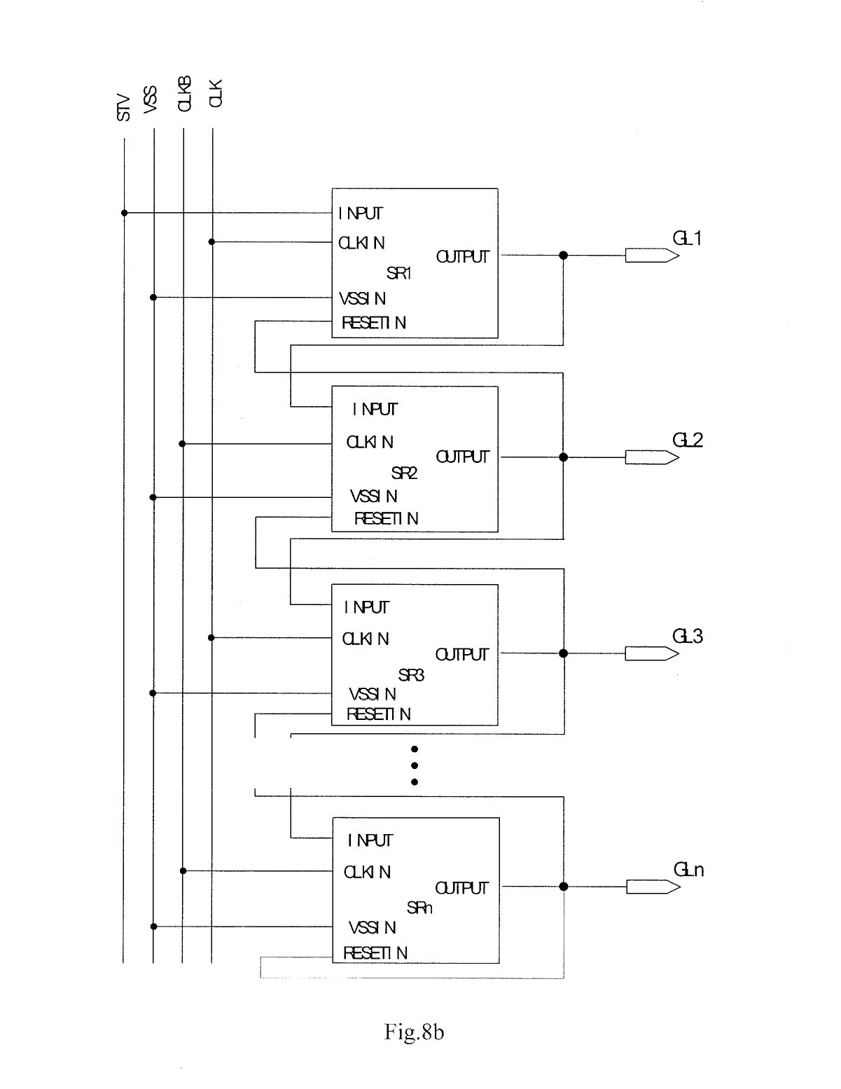

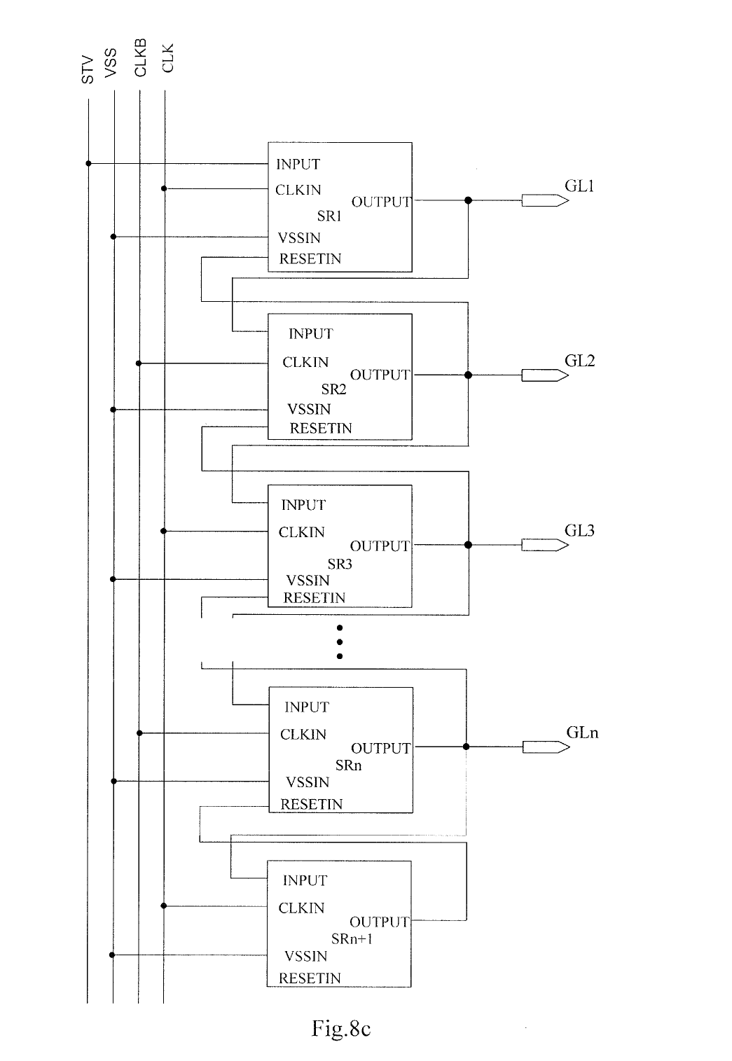

The first implementation is as illustrated in FIG. 8a. In this implementation, the gate driving apparatus of the liquid crystal display comprises a shift register SR1, a shift register SR2, a shift register SR3, . . . , a shift register SRn according to the embodiments of the present application; signals from control signal outputting terminals OUTPUT of the shift register SR2, the shift register SR3, . . . , the shift register SRn−1 are transferred to respective reset signal inputting terminals RESETIN of their own previous stage shift registers and the respective control signal inputting terminals INPUT of their own next stage shift registers. A control signal inputting terminal INPUT of the shift register SR1 receives an initial trigger STV signal, and a reset signal inputting terminal RESETIN of the shift register SRn is in a floating state.

The second implementation is as illustrated in FIG. 8b. In this implementation, the gate driving apparatus of the liquid crystal display comprises a shift register SR1, a shift register SR2, a shift register SR3, . . . , a shift register SRn according to the embodiments of the present application; signals from control signal outputting terminals OUTPUT of the shift register SR2, the shift register SR3, . . . , the shift register SRn−1 are transferred to respective reset signal inputting terminals RESETIN of their own previous stage shift registers and the respective control signal inputting terminals INPUT of their own next stage shift registers. A control signal inputting terminal INPUT of the shift register SR1 receives an initial trigger STV signal, and a reset signal inputting terminal RESETIN of the shift register SRn is connected with the control signal outputting terminal OUTPUT of the shift register SRn.

The third implementation is as illustrated in FIG. 8c. In this implementation, the gate driving apparatus of the liquid crystal display comprises a shift register SRL a shift register SR2, a shift register SR3, . . . , a shift register SRn, a shift register SRn+1 according to the embodiments of the present application; signals from control signal outputting terminals OUTPUT of the shift register SR2, the shift register SR3, . . . , the shift register SRn are transferred to respective reset signal inputting terminals RESETIN of their own previous stage shift registers and the respective control signal inputting terminals INPUT of their own next stage shift registers. A control signal inputting terminal INPUT of the shift register SR1 receives an initial trigger STV signal, and the shift register SRn+1 is a redundant shift register. A reset signal inputting terminal RESETIN of the shift register SRn+1 is in a floating state, a control signal outputting terminal OUTPUT of the shift register SRn+1 is not connected with any gate lines and only provides a signal to the reset signal inputting terminal RESETIN of the shift register SRn.

In any one implementation of the gate driving apparatus of the liquid crystal display, phases of the signals from the clock signal inputting terminals CLKIN of two adjacent stages of the shift registers are opposite with each other, for example, the clock signal inputting terminal CLKIN of the shift register SR2 inputs a blocking clock signal CLKB, while the clock signal inputting terminals CLKIN of the shift register SR1 and the shift register SR3 input a clock signal CLK; wherein the phases of the blocking clock signal CLKB and the clock signal CLK are opposite, that is to say, the clock signal CLK is at the low level when the blocking clock signal CLKB is at the high level, while the clock signal CLK is at the high level when the blocking clock signal CLKB is at low high level. Except the redundant shift register, each stage of the shift registers convents an input clock signal into an ON signal or an OFF signal and outputs the same to a corresponding gate line from its control signal outputting terminal. For example, the shift register SR1 converts the signal received at its clock signal inputting terminal CLKIN into the ON signal or the OFF signal and outputs the same to a corresponding gate line GL1 from its control signal outputting terminal OUTPUT, and the shift register SRn converts the signal received at its clock signal inputting terminal CLKIN into the ON signal or the OFF signal and outputs the same to a corresponding gate line GLn from its control signal outputting terminal OUTPUT.

The embodiments of the present application further provide a liquid crystal apparatus comprising the gate driving apparatus of the liquid crystal display according to the embodiments of the present application.

The embodiments of the present application being thus described, it will be obvious that the embodiments may be varied and modified in many ways. Such variations and modifications are not to be regarded as a departure from the spirit and scope of the invention, and all such variations and modifications as would be obvious to those skilled in the art are intended to be included within the scope of the following claims and equivalence.

What is claimed is:

1. A shift register, comprising:
a pulling-up module for connecting electrically a clock signal inputting terminal with a control signal outputting terminal under a control of a signal received from a control signal inputting terminal;
a resetting module for resetting a pulling-up node and the control signal outputting terminal under a control of a signal received from a reset signal inputting terminal;
a pulling-down module for connecting electrically the control signal outputting terminal with a low voltage signal inputting terminal under controls of the signal received from the clock signal inputting terminal and a signal at the pulling-up node, the pulling-up node being a connection point where the pulling-up module, the resetting module and the pulling-down module are connected together.

2. The shift register of claim 1, wherein the pulling-down module comprises a pulling-down driving unit and a pulling-down unit,
the pulling-down driving unit is used for outputting a driving signal to the pulling-down unit under controls of the signal received from the clock signal inputting terminal and the signal at the pulling-up node, and
the pulling-down unit is used for connecting electrically the control signal outputting terminal with the low voltage signal inputting terminal under a control of the driving signal output from the pulling-down driving unit.

3. The shift register of claim 2, wherein the pulling-down driving unit comprises a fifth transistor (T5) and a sixth transistor (T6), wherein both drain and gate of the fifth transistor (T5) is connected with the clock signal inputting terminal, and a source of the fifth transistor (T5) is connected with a drain of the sixth transistor (T6); a gate of the sixth transistor (T6) is connected with the pulling-up node, a source of the sixth transistor (T6) is connected with the low voltage signal inputting terminal; a ratio of size of the fifth transistor (T5) to that of the sixth transistor (T6) is a preset value.

4. The shift register of claim 3, wherein the pulling-down unit comprises a seventh transistor (T7), wherein a gate of the seventh transistor (T7) is connected with the drain of the sixth transistor (T6), a drain of the seventh transistor (T7) is connected with the control signal outputting terminal, and a source of the seventh transistor (T7) is connected with the low voltage signal inputting terminal.

5. The shift register of claim 4, wherein pulling-down unit further comprises an eighth transistor (T8), wherein a gate of the eighth transistor (T8) is connected with the drain of the sixth transistor (T6), a drain of the eighth transistor (T8) is connected with the pulling-up node, and a source of the eighth transistor (T8) is connected with the low voltage signal inputting terminal.

6. The shift register of claim 1, wherein the pulling-up module comprises a first transistor (T1), a third transistor (T3) and a capacitor (C1), both gate and drain of the first transistor (T1) are connected with the control signal inputting terminal, a source of the first transistor (T1) is connected with the pulling-up node and one terminal of the capacitor (C1), respectively, the other terminal of the capacitor (C1) is connected with the control signal outputting terminal; a gate of the third transistor (T3) is connected with the source of the first transistor (T1), a drain of the third transistor (T3) is connected with the clock signal inputting terminal, and a source of the third transistor (T3) is connected with the control signal outputting terminal.

7. The shift register of claim 1, wherein the resetting module 12 comprises:
a second transistor (T2) and a fourth transistor (T4), wherein a gate of the second transistor (T2) is connected with the reset signal inputting terminal, a drain of the second transistor (T2) is connected with the pulling-up node, a source of the second transistor (T2) is connected with the low voltage signal inputting terminal; a gate of the fourth transistor (T4) is connected with the reset signal inputting terminal, a drain of the fourth transistor (T4) is connected with the control signal outputting terminal, and a source of the fourth transistor (T4) is connected with the low voltage signal inputting terminal.

8. A gate driving apparatus, comprising a plurality of stages of the shift registers of claim 1, except a first stage shift register and a last stage shift register, a control signal outputting terminal of each stage of the other shift registers is connected to a reset signal inputting terminal of a previous stage shift register and a control signal inputting terminal of a next stage shift register; a control signal inputting terminal of the first stage shift register is connected to an initial trigger signal terminal, and a reset signal inputting terminal of the last stage shift register is in a floating state, or is connected to the control signal outputting terminal of its own directly or is connected to a control signal outputting terminal of a redundant shift register added.

9. A liquid crystal display apparatus comprising the gate driving apparatus of claim 8.
